(19) United States
(12) Patent Application Publication
(10) Pub. No.: US 2004/0049446 A1
(43) Pub. Date: Mar. 11, 2004

(54) Electronic trading system

(76) Inventor: Kay Seljeseth, Baerums Verk (NO)

Correspondence Address: CONLEY ROSE, P.C., P. O. BOX 3267, HOUSTON, TX, 77253-3267, US

(21) Appl. No.: 10/343,895

(22) PCT Filed: Aug. 3, 2001
(86) PCT No.: PCT/NO01/00331

(30) Foreign Application Priority Data
Aug. 4, 2000 (NO) 20003978

(51) Int. Cl. G06F 17/60

(52) U.S. Cl. 705/37

(57) ABSTRACT

It is described a trade and marketing system for trading in an electronic medium, and especially for Internet. The system comprises a data technical infrastructure, algorithms/rules and modules, which together constitute a total system for performing all steps in a trade; from marketing the commercial goods to payment and delivery of the goods. The system creates an international electronic trading place on the net, which opens for easier trade on the net over the country borders.

### FIELD OF THE INVENTION

The present invention concerns trading in an electronic medium, in particular an electronic trading system and a method for performing trading in an electronic medium such as the Internet.

### DESCRIPTION OF KNOWN TECHNOLOGY

The Internet represents an international and border-less medium that is flexible and that technology wise allows anyone to see virtually everything that is published. This new medium is international and it does practically increase trading across country borders, still the potential offered is not utilized by far and it is obvious that the Internet of the future will differ from the Internet of today. Major players such as EBay, Amazon.com and the different auction services such as CoShopper, QXL and others was established with service offerings that first of all focus on a primary market, but that allow buyers in other markets to buy objects from these auction services, but then according to the premises that are valid for the primary markets of the service providers. The Internet and E-Business of today is in its early stage of changing our way to communicate, but there is currently a lack of mechanisms for communication, standards and a high level common denominator.

Traditional trading systems typically offer one or more fixed channels (eq. forwarders, ways of transportation, resellers or distributors) to complete a trade and fulfill a delivery. These do typically contribute only with a limited part of the full trade and are usually not chosen with respect to each single trade being performed. This is a limitation for Internet based trading as trust and totality of the trade pattern is more complicated and less obvious for the actors/buyers compared to a traditional trade pattern.

In international traditional and electronic trading there is today often uncertainty when it comes to calculating prices, taxes and other costs. The buyers will normally themselves be required to perform all calculations and pricing to be able to find the actual price for an object being located in another market than the home market.

To be able to calculate the current price it is likely that the buyers themselves will need extensive information about both the sales objects and markets involved. This is a major obstacle facing many buyers, and a factor that does contribute to uncertainty. This results in less trading across country borders. There is usually a lack of relevant information in trading- and information systems related to selling objects into other markets than the traditional market.

Secure payment and settlement does impose uncertainty in parts of Internet based trading of today. This is because geographic distance and other barriers such as language, market and such is an obstacle between buyers and sellers. Actual control of the trade is typically not satisfactory. Services that supports deposit of payment and secure payment (eq. the ESCROW service) partially removes this kind of uncertainty, but are complicated, time consuming and expensive in use. Other known systems are described in U.S. Pat. No. 5,909,492. This patent relates to a system for grouping and securing payments from on or more buyers and sales systems into one payment system that in a secure manner controls the transactions and approves delivery of sales objects to the buyer. The system allows for the support of several trades being placed for several systems from a single buyer in such a way that the payment is being done to a single point. A solution for securing against changing currency exchange rates is described in U.S. Pat. No. 5,897,621, The buyer and seller is given a fixed price in their local currency for a trade being approved by a third party. The third party undertakes the risk for any currency fluctuations. More simple ways of “control” is imposed cash on delivery which does allow for some security for payments, but this systems is vulnerable with respect to fraud and lack of content in the delivery/settlement. Carrying out the trade personally brings about practical inconveniences and usually higher costs.

U.S. Pat. No. 6,041,308 describes a system where buyers may specify their terms for buying and where a compensation for non-fulfilled trades may be adapted. It is described a technique for compensating the buyer when a trade is not fulfilled through a “conditional buy” (CPO/Conditional Purchase Offers). Compensation is given conditionally and the system described in the patent checks if such conditions related to a non-fulfilled trade are met. The system described is isolated to making buy orders more attractive through compensating non-fulfilled trades and it is not a trading place solution.

U.S. Pat. No. 6,026,374 describes a system for filtering/selection of information that are being presented about a trading object on a trading place on the Internet. The system is based on a third party or a program that does have access to all information needed to create a relevant abstract for the buyer. The intention is to protect the full information from a buyer, unless this is purchased or accepted by a receiver somehow.

U.S. Pat. No. 6,016,504 describes a method and a system for tracking of trades that takes place on the Internet. The technique is based on virtual connection controlled by a central web site (eq. a service run by a producer) that controls the presentation and trades of a product via for instance a resellers web site in such a way that the user experiences that the reseller is offering the information, service and trade taking place, while it in effect is taken care of by the central web service. This technique is focused on distributed trading and the support of existing roles in the presentation of information and fulfillment of trade. This concept does however not describe a trading place.

U.S. Pat. No. 5,970,472 describes a mechanism for linking sales of a producers products to a reseller in such a way that the product from the producer in speak is presented alone on the resellers web site, that otherwise may contain products from several producers. Another intention addressed by this concept is to control that a producers products may only be sold through an authenticated channel, in order to avoid non official channels/copied products. The technique does not represent a trading place, but does address the problem of allowing a producer facing an open Internet market to sell their own products through resellers without having their own products being offered in competition with other products, whenever the producer has initiated the trade with the buyer. The concept of this patent is furthermore focused on isolating product information than to present and trade products in an open trading place.

U.S. Pat. No. 5,895,454 describes a technique for collecting information on products offered by different producers into a shared database, and based on this centralized information directing users to the different provider web services. Simultaneously, information is logged on the usage of the providers' web services into the central systems. This techniques used in a simple way is similar to the technique found in the so-called portals where links to web sites are grouped and where links to the providers may be found. The patent does however go one step further as more information is gathered than what is the case with most portals. In short, the patent may be described as a portal solution and not a trading place.

Also, web sites linking appropriate buyers and sellers of properties are known. One such system is described in U.S. Pat. No. 5,664,114. The properties for sale are selected based on the buyers' information regarding desired area, price, type of property and other information. Buyers that do not qualify according to given criteria's may be excluded.

Items being traded over the Internet and through traditional computer systems are today described to some extent of detail through the use of text, numerical values and/or Boolean (yes/no) values. For an international presentation of an item a text based and also sometimes a numerical description of an object will not be sufficient with respect to the extent and/or precision to give enough information regarding what the item is really about.

The description “95 model BMW 316i” may as an example introduce a number of different interpretations. This car may in one particular market have a 1600 ccm engine, while it in other markets may have a 1800 ccm engine. Furthermore, it may be major differences in equipment, type of drive gear and such both within and between markets covered by this description. The lack of information about important properties will effectively prevent a buyer or a system from performing customs/tax calculations and to calculate the total price when selling to another market, thereby reducing the possibility to evaluate the items' actual form and value. No known Internet based systems does define generic items in such detail that trading in several markets can take place without leaving uncertainty about what a trade will entail when it comes to important details, such as for example the price. Simple items that are synonymously defined by an item name or a standardized/well known product number does exist, but in such cases the item is likely to be described through the standard itself or the well known abbreviation and not through the detailed information in the computer system that the item is being traded through.

Actors (sellers, buyers and agents) are in a similar way most often described through a rather coarse category definition such as “private buyer”, “reseller”, “producer” and such. In addition to this it is likely to be a textual based low precision description of the actor in speak that does define the services and properties the actor may perform towards others. In certain markets and within certain actor groups there exists standards that define actors and agents, but this is information that often is not relevant or sufficient for an electronic and automated trading place or the information is not used directly as a part of a trading system.

Typical information being offered an Internet user of a trading place about a forwarding agent (an agent in a trade) may be for example “FedEx Corporation provides integrated transportation, information, and logistics solutions through a powerful family of companies that operate independently yet compete collectively”.

The technical limitation is that the databases with this kind of generic item/agent descriptions have a format where objects are only partially described. Internet sites such as EBay, QXL and YaTack that trade different types of items will typically describe the item with text, which makes it practically impossible to process the information.

Today's trading places on the Internet are likely to be named as B2B (Business to Business) or B2C (Business to Consumer). The trading places for these players are usually built based on the existing way of doing business found in a company or an organization. Some branch oriented trading places do also exist. Exchange of orders, delivery information, invoices and other do usually take place via paper or electronic formats, such as EDI and also more and more often via XML directly with the trading counterpart on these trading places or E-Business solutions. This implies that different parts of the business processes take place in different ways between the different players and Internet plays a limited role as an integrating trading place with a common way of performing business. Internet used as a trading place does often “only” provide the business processes: information exchange, advertising, bidding and the entering of a purchase agreement. Also, this does imply that an Internet based trading place does become an addition and an extra load to existing systems and processes and not a replacement or improvement of the existing systems.

In today's Internet trading solutions the variety of number of items, types of players and totality in the system is limited in such a way that this challenge is not addressed in other ways than for instance providing different ways of shipment and a limited choice of regular agents.

Foreign languages, unfamiliar markets, unknown import rules and unknown item properties flourish in today's Internet based trading systems. The latter does appear most clearly when one is trading across country borders and with items or services that are not clearly defined.

The price for a car in Germany will for instance be radically different from the price when the car is imported to Norway. In addition the language used, use of abbreviations and such entail that the buyer will need to use their own interpretations, price calculations and it is likely that the buyer also will need to gather additional information about the car in order to have a tangible decision bases for a purchase. That this is the situation today is being exemplified by the presence of import tax calculators for cars on the Internet (eq. Bilmegleren.no) and furthermore numerous car import companies that provide support to the trade process by contacting a seller in Germany in order to check details about the car's condition and more. Calculations and control of cars as an import item do today mainly happen is manually for each car.

The language challenge is today primarily solved, by translating texts describing items and players between different languages. In future systems this will not be acceptable because descriptions must immediately be made available when additions and changes are to be made. This requires that the computer system automatically is able to prepare information in several languages. The understanding of this challenge is obvious through the strong focus that is found on companies that are working with language translation technologies.

It does exist systems for verbal translation of texts, but these do partially lack precision and cannot be used for calculations, algorithms linked to an item and are so unsafe that a translation cannot be used with confidence as a part of a contract or such.

Secure trading has become one of the most focused areas within Internet based business. Standards in the area of payment via the Internet are in their first phase, while the second phase will focus on avoiding fraud in the trade and control of compliance between the description of the sales item with the actual condition of the item so that the settlement as a total can be secured for all participants.

Today's solutions (EBay and others) offers secure settlement by using Escrow based services as an addition to the services of the trading place or by ordinary insurance of trades. This does partially imply that one will need to establish contact with an additional player and partially mean that the control of the items is being left to the players and the controlling authorities that have been agreed. An insurance will partially entail an additional cost that needs to be included in the trading system. An insurance does also do little when it comes to preventing fraud or non compliant trades in the trading place.

Today's Internet based sales channels do often follow traditional trading patterns and market borders. An end customer will typically buy from a reseller, which in turn buys from a distributor and so forth. This creates a base for companies that has a primary task to distribute goods within the established trading channels. The future Internet E-Business is expected to be more split into more players and into new trade channels.

Traditional and Internet based trading is today to a large extent limited by country- and language borders making trading more complicated than what the case is with trading in a homogeneous market within a country. So far this has been the accepted way of trading, but if the future of borderless Internet trading is going to happen technology and processes will be required to aid removing these borders and thereby realize true global and borderless trading.

A market may be defined in many different ways, but in this context one market is different from another market when there are conditions that separates the different markets in such a way that trading cannot take place transparently between the markets in the same way as the trading takes place within each of the markets.

Classical borders in this context are customs and tax rules. Today such rules make it complicated to calculate prices between markets and bidding and negotiations regarding price and terms do often become a specialized process.

Trading between markets does often become insecure and ends with an unexpected result because the actors do not know the rules that are applicable in the market being traded with. Because the technology behind today's Internet based trading systems does not support precise object definitions, applicable laws and practice, this remains an obstacle for international trading.

Specialized trading systems do take care of the presentation of relevant information in many cases, but the systems used cannot be used for presenting generic and targeted information for trading items in a generic context.

The settlement between trading partners are in generic trading systems in the new electronic mediums left to the actors or to a third party settlement system. This is the case because the traded items are not being defined in detail and because rules and agreements are not tied to the items and markets from the beginning. This entails a complicating link for international trading and is in practice a barrier for many actors and types of trading objects. Hence, users do experience that the Internet is not secure. Many trades are therefore being completed using a traditional trading process and thereby leaving Internet to be a marketplace primarily.

One may say that the structure of the markets and the geographic borders mainly have been kept even after the Internet has been growing vigorously over the last year. Because Internet is international many buyers may still trade in other markets than the primary market, but they will mainly need to adapt to the sellers market. The reason to these limitations is based on the fact that the technology needed is not available and that it because of this has not been possible to implement to allow the Internet to become a new medium and trading place.

In the same way as the traditional industry has developed from being a “one of” production via a copied-production to mass-production industry the Internet will develop in stages. Compared to the industrial development one may say that the Internet of today in principle represents a “one of” production stage or in best case the stage of copied production. The Internet parallel to mass-production has not been realized because an implementation of computer technology does not exist. References are made to the future of Internet by saying undefined that the Internet is a global marketplace or an open market. No actors has however solutions or do operate in such a way and may therefore claim to offer the main components that will constitute such a market, this because no one has discovered how a computer based solution will need to be constructed.

Amazon.com and Ebay are some of the major players on the Internet. Instead of such islands of operations the Internet will become as a network with communication, products and services. So far no one has seen how this model can be supported, but many technical and structural challenges have been described.

By utilizing today's technical and structural solutions it is difficult to trade items in an electronic market place and a trade involves multiple manual operations, higher cost, reduced precision in the information, longer time of processing, reduced confidence to the new mediums of trade and a number of other drawbacks that today appear obvious.

Because an embracing concept for trading over the Internet has not yet been understood the technology being required has not been considered at all. Hardware and basic software exist that will become foundation stones in an embracing system, but how these may be utilized is not at all clear. The real challenges that exist with respect to an embracing system will in total need to be supported by an stable, fast, flexible, complicated and large computer system.

Today's trading places are often primarily a combination of an advertising medium and an auction house without the possibility to integrate product information and exchange information about logistics and orders with a larger number of different types of actors. Actors and agents have because of this today typically little direct integration with external Internet based trading places.

Technologies such as EDI and XML are used to some extent, but do not offer something even close to the functionality that is desirable in combination with the open trading places of today and are primarily used in one-to-many relations and/or with individually information content. This does in practice allow for so many variations that it today does not exist any standard for definition of items, except what may be found within specific areas.

In an electronic trading place with a variety of types of objects, markets and actors involved and integrated it will be required to have different types of agents to fulfill the trade unless the actors themselves are required to do also this part of the trade. Examples of such agents are forwarding agents, transport agents, controlling functions, importers and resellers. No computer based solution does exist that can carry out the process of choosing agents in the way future Internet trading systems will require.

The objective of the invention is to remove/reduce the problems found in the electronic trading solutions as described above, and to accomplish a system that links together as many buyers and sellers as possible in an international electronic trading place that removes the geographical and economical trading barriers, and that opens trading in several branches and between different markets, entailing major opportunities for profit an advantages to both buyers, sellers and agents.

### BRIEF DESCRIPTION OF THE INVENTION

According to a first aspect of the invention it has been provided a system for accomplishment of trades in an electronic medium, comprising central systems for primary data storage and processing, an electronic trading place for advertising and trade of trading items, means for automatic price determination of the trading items and determination of terms, means for selecting at least one agent for at least one actor in each trade, given specific criterias/parameters, and means for the closing of a trade.

Preferred embodiments of the trading system are specified in the independent claims 2-19.

According to another aspect of the invention it has been provided a method for accomplishing trades in an electronic trading place in an electronic medium, where the method comprises the following steps: to advertise trading items for sale or advertise a purchase request in the electronic trading place, to close a trade of trading item(s) between actors or between the trading place and an actor, where the trading place automatically determines the price on the trading item(s), and automatically selects agents for fulfillment of each trade based on specified criterias/parameters; and finally the settlement of each trade by means of trading item control and settlement.

Preferred embodiments of the method for accomplishing trades are specified in the independent claims 21-34.

The trading system does in a preferred embodiment comprise a computer based infrastructure, use of Internet or other medias for accessing the trading system, rule systems for the calculation of price and determination of terms, language modules, automatic inclusion of agents for the accomplishment of trade, an object oriented method for presentation of items for sale and a method for safe settlement for the trading. The system constitutes, based on the mentioned elements, an integrated trading- and advertising system for trading over the Internet, which hereafter is named the trading place.

The trading place does support traditional functions such as advertising, price information, auctions and information about delivery and settlement for trading. In addition the trading place have unique functions such as the automatic selection and/or prioritization of agents (AGENT) for the fulfillment of trades, automatic rule systems (RULES) for price calculations for items being traded across markets and an integrated item control and settlement system (TRADEPAY). Compared to traditional Escrow services the trading place includes the settlement system as an integrated part of the trading process. It is not necessary to register a trade to use the settlement system. Furthermore different types of trading items may be processed differently based on defined rules/item requirements. Third party agents may be used as an integrated part of the system for approvals.

The trading place offers, as a result of its architecture, business model and the computer technology model, a solution named EBUS. EBUS is an abbreviation for E-BUSiness as a business concept or relates to E-Business BUS or E-Bus. The latter term reflects that the trading place system may be viewed as a bus system, where actors may easily connect into the system. This is achieved through a computer based solution that offers tasks to be split between the trading place and the actor's financial/logistical systems. The EBUS solution is based on a format that is directly linked to the object categories and the other functions of the trading system, but it can be integrated with other standards by the means of translators (for example an EDI interpreter).

The trading place has a precise description of each actor that specifies in detail what markets are being supported, the cost of services provided and more such information. This information is structured and available for the automated systems in the trading place, in such a way that the selection of an actor is well qualified when the trading place deals with different kinds of objects between different markets and types of actors.

Objects have defined properties that may be linked to several languages, thereby avoiding a verbal description that needs to be prepared in multiple languages. No Internet services do provide this kind of computing method in generic trading systems today.

The trading place includes secure settlement in addition to secure payment as an integrated part of the trading place. No other trading places do today use an integrated settlement system for generic objects that also support detailed control as a part of the process. This is primarily because the description of the objects and the basis for control of the objects is left to the actors from the beginning.

The trading place does include a technological solution to integrate the trading objects and the trade with a settlement system, especially between different markets.

The present invention includes the following: A technological solution for defining objects and actors in a trading place in an electronic medium, especially the Internet, a technological solution-for including existing operations in a trading place, a technological solution for the selection of agents needed to fulfill a trade, a technological solution for the presentation of sales objects in a multi market and multi language setting, a technological solution for the control of settlements in an integrated trading system, changes in sales channels and traditional market channels, the removal of country borders with respect to trading issues if other markets are to be exploited, easy fulfillment of trades between markets, where the trading place automatically deals with laws and rules in different markets, and also takes care of secure settlement of the trade.

The invention describes a solution where the utilization of technology and related processes makes it easier for different kinds of actors to trade through an electronic trading place. The invention accomplishes better communication and processes for trading and removes many of the borders and barriers that are typically found in traditional and Internet based trading and dialogue today.

The invention does furthermore accomplish an open framework and network for communication and trading between an unlimited number of actors. Relationships are supported by the invention in such a way that it becomes easier for the actors to trade. The trading place is a technological solution with controlled processes that may be built to support many-to-many trading within branches, market segments or as a service for “all” trading on the Internet. The solution may be built as a singular trading place, as several separate trading places and/or-as trading places linked together in one or many networks.

The first implementations of the invention will most likely support fairly simple trading similar to the traditional trading patterns that are common today. Later implementations may support singular trades where a number of actors (including agents) are involved and where the product being traded is acquired with assistance from more actors than what is common today and where each of these are more specialized. The definitions of a buyer, seller, agent, object may become dimmer compared to the definitions of today as trades will change by the present invention.

Automatic actors and functions outside of the invention will also contribute to a wider and more comprehensive utilization than what may be apparent.

The invention will in this context take care of the definitions, and the process control that is required in order for a large number of different entities to communicate and coordinate its actions in such a way that “smart” trading arise in a wide sense.

Trading objects may with the invention in the same way be split into partial objects within a category or across categories and these may be linked into trades different from the typical trading model of today. New terms such as “trading cells” will arise because the invention allows grouped objects and actors. Such trading patterns are not described as a technology in the invention, but will be possible by utilizing the technology platform. A trading cell may as an example contain several actors trading together, but which trades different parts of a (partial-) object or an actor that trades different parts of an object from different actors in a single trade. Actors may have their own web sites with only their own information in addition to, or instead of information found on the open trading place.

### BRIEF DESCRIPTION OF DRAWINGS

The invention will in the following be described in more detail by referring to the enclosed figures where:

FIG. 1 shows in short and as an example how the table structure and content typically will be built to describe defined trading objects according to an embodiment of the invention;

FIG. 2 shows in short and as an example how the table structure and content typically will be for an agent according to an embodiment of the invention;

FIG. 3 shows in short and as an example how the table structure and content typically will be for a buyer or seller according to an embodiment of the invention;

FIG. 4 shows how objects are being defined with information from multiple tables according to an embodiment of the invention;

FIG. 5 shows a screen shot for a car as an example in the trading system according to an embodiment of the invention;

FIG. 6 shows the same data objects as in FIG. 5 being presented in Norwegian;

FIG. 7 shows a detailed screen shot for a sales object according to an embodiment of the invention;

FIG. 8 shows a part of a screen shot in German language for adding a car to the system as this looks for the user according to an embodiment of the invention;

FIG. 9 shows another part of a screen shot in German language for adding a car to the system as this looks for the user according to an embodiment of the invention;

FIG. 10 shows examples of sales objects that may be supported by the system according to an embodiment of the invention;

FIG. 11 shows a screen shot with a login screen for users according to an embodiment of the invention;

FIG. 12 shows how the same database and the same system support a reseller through the use of a separate service;

FIG. 13 shows an example of the looks of one of the administrative screens for controlling high level categories;

FIG. 14 shows one of the screens for the administration of actors and agents according to an embodiment of the invention;

FIG. 15 shows a table with key information about different countries supported by the system according to an embodiment of the invention;

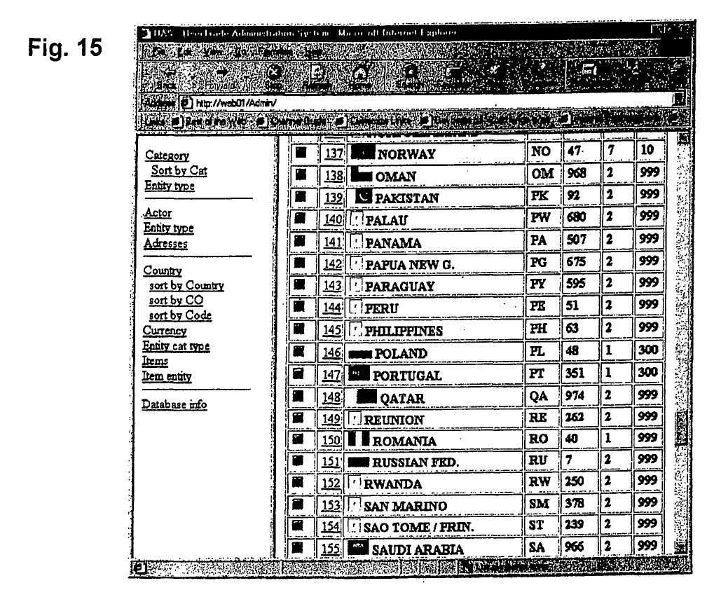

FIG. 16 shows properties linked to a sales item, in this case a car;

FIG. 17 shows a screen for the administration of trading objects according to an embodiment of the invention;

FIG. 18 shows the principles of the trade object presentation process according to an embodiment of the invention;

FIG. 19 shows an outline for the settlement system according to an embodiment of the invention;

FIG. 20 shows an example of a screen for bidding in a multiple market according to an embodiment of the invention; and

FIG. 21 shows the principles of the different modules of the invention and how the trade is being controlled.

### DETAILED DESCRIPTION OF THE INVENTION

The trading system does in addition to the traditional functions, such as advertising, price information; auctions and information about delivery and settlement, include functions for selection/prioritization of agents, automatic rules systems, and object control- and settlement. These are described below.

Selection and/or Prioritization of Agents

An agent in the trading place is an active and substantial part in the fulfillment of a trade. The extent of involvement will vary from a-passive forwarding/control function to a total fulfillment of a trade as a partial function in the trading system.

One or more agents will be selected by the trading system per trade based on criterias such as type of activity, geography, competence, experience and other considerations regarding how suitable the agent may be. The trading place will, based on information on the agent, the buyer, the seller, the object and the markets involved, be able to make an automated prioritization and selection of agent(s) or suggest suitable agents.

In contradiction to known solutions the trading place will itself choose or recommend one or more agent(s) for the buyer/seller. The selection is automated as a result of fetching information and statistics from platform databases and involves algorithms or the use of criterias set by an actor to find the most suitable agent.

Agent(s) may be prioritized based on parameters related to the seller, buyer, object and markets where these are located and existing information about the agents.

The parameters will at least cover the following within each main function: Seller/buyer:

Native country/geography

Language

Rating/statistics

Outcome/evaluations of previous trades

Preferences

Age, financials and social background

Competitive elements

Service

Time of delivery

Way of settlement

Others

Agent:

Object category that is supported and experience in these

Financial rating and statistics

Outcome/evaluations of previous trades

Rating of geographic nearness

Competitive elements

Service/Time of delivery

Way of settlement

Language

Price of service

Others

Object:

Object category

Price

Object approvals

Guarantee/Service

Weight and size

Security classifications

Temperature- and environmental requirements

Handling requirements

Fresh goods/durability

Product standards

Market standards

Other rules/circumstances

Settlement/security of payment

Others

Markets:

The location of the market/distance

Export rules

Import rules

Transport conditions

Language

Others

The prioritization may utilize a set of algorithms/rules that prioritizes the properties mentioned automatically or by showing the properties to the actor in order for this to choose the agent, as an alternative this may be in a prioritized sequence. The basic information is located in the central databases and is being presented as a result on the client of the user. A client may in this context be an Internet/HTML based interface, a traditional user interface, telephony, WAP and/or other technologies.

Another option is to choose and/or prioritize agents by comparing relevant parameters and possibly mathematically balance these to find the agent that is the best match from a point of view that is as much objective as possible. Rating and other statistical information is the foundation for rendering the quality and ability to perform that one may expect the agents to possess. The agent selection may then include threshold values/limits that exclude agents that do not satisfy set requirements.

Technical Solution

A client system is being presented prioritized or selected agents based on the information and selection criterias in the trading system.

The trading system consists of central systems and clients connecting into these. The central systems mentioned here contain central systems or distributed systems that are not directly a part of the client. The central systems take care of functions such as primary data storage and processing. Data storage may also take place partially in the client system, but this will primarily be the case with information related to the system actor in speak. Rules processing will take place either in the central systems and/or in the client.

Information and parameters are related to actors and agents in the system. This information is stored primarily in the central systems. Databases are used for storage in the central systems. The processing that takes place will be related to storage/retrieval of data, financial calculations, rules calculations, calculation of priorities/recommendations, comparison of statistics, data validation, processing of statistics and full or partial preparation of information being presented.

The trading system does however also allow for client to client comparison of parameters and properties for the selection of an agent, selection of agent(s) based on the actor information regarding the desired parameters and also selection of agent(s) based on standardized information about an agents relationship to a preset type of trade.

Automatic Rule Systems (RULES)

Usually trading- and information systems have limited relevant information about objects being sold into other markets than the traditional market. The present invention describes objects in such detail that it is possible to perform precise calculations on objects that are being traded between different markets. Rules that are an integrated part of the central systems of the trading system calculates and presents prices and terms together with other information per sales object within and between present countries and/or markets. The trading system will consider the market of the seller and buyer, but the sales object may also be traded between markets independent of the location of the buyer and seller. Calculations and rules processing is taken care of in any case.

The rules and thereby the calculations are based on parameters that cover at least export/import rules, customs tariffs on applicable sales objects, the country/market of the actors, cost of shipment/handling and guarantees.

All applicable taxes/duties and other costs related to the trade are included in the price being shown for the sales object in question to a buyer on the trading place.

The applicable rule that is being chosen in each case of trading is being selected from a defined but extendable set of parameters being stored in the database, being set in the client system or is being chosen by the actor in speak when retrieving information.

The parameters for choosing a rule are at least:

The market from where the object is being sold

The market to where the object is bought

The currency and market of the seller

The currency and market of the buyer

The category of the object with respect to tax- and duty rules

Object properties

Optional agent information

When an applicable rule has been chosen, this rule is being activated with further parameters being required for a calculation. The result is being presented to the client system or is being stored for later presentation/use.

Parameters that are relevant in addition to the above mentioned are:

Tax-/duty tariffs

Export rules

Import rules

Freight/transport

Object category/type of goods

Price of the object

Tax deductions

Weight, volume and other properties

Security classifications

Temperature- and environmental requirements

Handling requirements

Fresh goods/durability

Product standards

Market standards

Guarantees and obligations

Agent costs

Other agent information

Others

Technical Solution

Rules are stored in a trade system as modules, which are performed with the actual parameters. Which rules that shall be performed are decided by the system based upon from-market and to-market for the trade object, and other parameters. One single object can be presented with different prices, conditions and information in different markets by using several rules.

Parameters concerning the trade object are being stored in a database where a number of properties describe the object in adequate detail so that an export and an import calculation can be performed. For some trade objects it is requited a further description to be able to calculate local fees and control other conditions. Such further information is also stored in a database.

Information about the players market and any agent information are stored mainly in a central database. Some information can be fetched from client systems at the players or agents. Information about players is used together with information about the trade object and actual markets for choice of actual rule and to provide the rule with necessary basic parameters.

The calculated price information and any further information is possessed in the central systems and introduced on the client systems of actors and agents. The presentation is likely in the form of price information for single objects in a shopping list or as detailed information concerning one single object. The client system is typically based on Internet terminals (browsers) with HTML/XML based protocols and Internet as transport medium. The solution can also comprise client systems based on client/server solutions, telephony, fax, WAP, SMS and other technologies allowing presentation of information at an actor.

The trade solution is tolerant with a view to lacking information in given circumstances. When information is lacking, the system will fetch statistical and/or extrapolated information and use this in the calculation. In such cases it is especially reserved lack of precision in the calculation and the delivered information.

A calculated price or chosen information can be calculated and is presented for the user of the system dynamically and/or stored as an intermediate stored value in the system. Possibly, information can be stored for later use in the central data systems upon installation of the object or at a later time. The system will calculate prices and fetch information once more if rules, properties or parameters change after an information/price is stored for the actual object. Rules can be stored as code in web pages, in so called business objects, in other software, as functions in the database or in other ways in the central systems. Rules can also be delivered to the client systems for calculation outside the central systems.

Other possibilities are manual feeding of information for calculations. The trading place can also perform reversed calculation to find an actual price in the market or origin based upon a given price in the to-market. An alternative to that everything shall be incorporated in the trading place is that a third party calculates and delivers information based upon information from the central systems.

Integrated Object Control and Settlement System (TRADEPAY)

The trading system follows a trade from start to end in the system. This comprises at least presentation of the object, auction/sales process, trade conclusion, deposition of payment, control of flow of goods, control of state of the goods, actual delivery and payment to the seller.

Information in the trade system is used for control of objects, verification of actual transactions, price settlement in each single link and approval of payment of settlement. A third party as bank and/or payment system is a part of the trade system.

The system differs from other systems in that actors, agents and/or the object that is being traded are defined in the system in such detail that said control mechanisms and actions can be performed automatically or with minimal manual operations without the use of a third party.

The trade system registers a sales object which is being laid out for sale and follows this until deposit of purchase price, control of object, delivery of object and settlement has taken place. The single actor in the trade is registered and known by the system. Sales objects are being defined in detail such that the actors accept the description of the object as a basis for the trade. Buyer or an agent will be controlling function for the object. This implies that one of these shall inspect and allow the object before settlement can take place. The buyer pays when the trade is settled whole or part of the purchase sum as deposit to the trade system. The purchase sum is deposited at a third party or a client account such that the sum is secured according to practice and law for brokers.

For trades where agent is control function the sequence is as follows:

Trade ended

Deposition of whole or part of purchase sum

Control of the commodity performed by agent

Payment of the rest of the purchase sum to the trading place

Payment to seller

Delivery of goods to buyer

For trades where buyer is the control function the sequence is as follows:

Trade ended

Deposition of the whole purchase sum

Delivery of the merchandise to buyer

Control of the merchandise by buyer/objection within time limit

Payment to seller after allowance or expired time limit

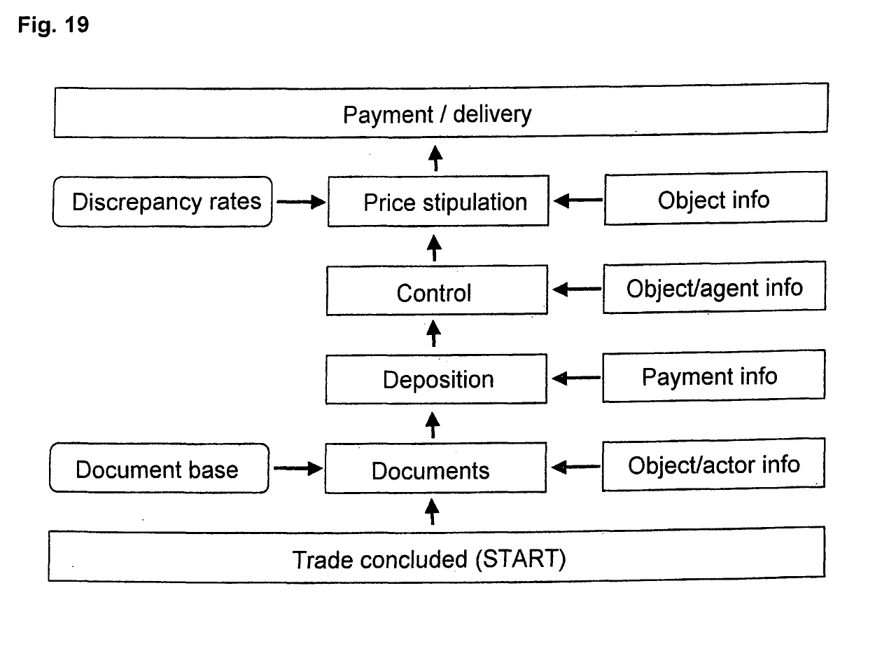

An important built in function in the trading place is that documents, contracts and transactions are being issued and performed as a process in the trading system. For goods, general documents are used and transactions, while for objects being defined in detail (capital goods) documents are issued adapted to the category of the object. The process is shown in FIG. 19.

After ending of a trade where agent is control function (Trade/Trade) it will in principle be issued the following documents according to the process:

| | | | | Trading |
|---|---|---|---|---|
| D cument | S II r | Buyer | Agent | place |
| Trade ended | | | | X |
| Document describing sales object and | X | X | X | |
| the trade in greatest detail | | | | |
| Deposit slip to buyer | | X | | |
| Payment approved (a) | | | | X |
| Delivery/possession from seller to | X | | X | |
| agent | | | | |
| Control document | | | X | |
| Approval of object (b) | | | X | X |
| Payment of eventual balance | | X | | |
| Balance payment approved | | | | X |
| Delivery of object from agent to | | X | X | |
| buyer | | | | |
| Payment of sales sum and agent | X | | X | X |
| provision | | | | |
| Trade completed | | | | X |
| Other documents | | | | |
| a) Payment not approved | X | X | X | |
| b) Return document for not approved | X | X | X | |
| control | | | | |
| Formal documents connected to | | | | |
| object and/or market | | | | |

After ending of a trade where buyer is control function it will in principle be issued the following documents according to the process:

| | | | | Trading |
|---|---|---|---|---|
| Document | Seller | Buyer | Agent | plac |
| Trade ended | | | | X |
| Document describing sales object and | X | X | X | |
| the trade in greatest detail | | | | |
| Deposit slip to buyer | | X | | |
| Payment approved (a) | | | | X |
| Delivery/possession from seller to | X | X | X | |
| buyer (possibly via agent) | | | | |
| Control document | | X | | |
| Approval of object (b) | | | | X |
| Payment of sale sum to seller and | X | | X | X |
| possible agent provision | | | | |
| Trade completed | | | | X |
| Other documents | | | | |
| a) Payment not approved | X | X | X | |
| b) Return document for not approved | X | X | X | |
| control | | | | |
| Formal documents connected to | | | | |
| object and/or market | | | | |

Documents in the trading system can be paper based, based on email content, web sites or other media. Where there are formal demands on approved documents, these are used in addition to the documents that are being issued automatically by the trading system.

Technical Solution

When a trade has been ended, the sales object is placed in a defined settlement process where it goes through a number of processing phases. The phases are controlled by change of processing status (examples on status are being found in the paragraph “A trade ends . . . ” on page 40) on the sales object, and/or change of processing status on involved actors and/or agents in the database of the trading place. When entering into a phase, normally a number of actions will occur and to end a phase normally one or more conditions must be fulfilled.

The information are being stored in a central database and actions happens automatically, or perhaps manually, by issuing of email, fax, transactions, publication on Internet or in other ways. Issuance and actions are taking place with basis in the present information about each actor involved.

Prices and delivery conditions are being controlled, possibly adjusted and approved in the same way by receipt of information that is checked by agent or buyer against detailed information about the sales object and present status in the trade system. E.g. an agent will check if a car actually has the condition corresponding to the detailed information a seller has given about this. If there are differences these will be entered into the settling system, which based on its rules can adjust the price or cancel the trade.

The use of Internet based client systems can be used for making available information concerning processing status, the actors and the trade in other respects. The central systems will with such an discrepancy publish the actual information and this is made available via Internet based protocols e.g. HTML, for the actors by the use of a form of authentication for reading of the information. Offsets will be handled by the system either automatically or by manual mode of treatment.

Transactions can be handled by follow-up of electronic information concerning payments to client account or by manual control of information about performed transactions. Use of manual or automatically follow-up must happen based upon current laws/regulatives for settlement systems, but a large as possible degree of automation will increase the service's value and efficiency. Control of the state of the object can take place by the use of agent or the buyer himself approving the object. The detailed information, which is the basis for the approval, is part of the information in the trading system. An approval of a sales object is normally fed automatically into the process, but can also take place by manual operations.

Authenticating and/or encryption can be used for securing transactions, approvals and access to the rest of the information.

Other possibilities are that a third party controls the settlement as for instance in escrow.com. Another alternative is that manual control of status and treatment of settlement take place in an own system.

Inputting of Sales Object—EBUS-Based Trade

The present trade system basis it's integration against actors and agents on another technology than EDI and XML and another structure than today's trading places. EBUS defines in contrast to what up till now has been usual a simple and unambiguous framework for a format for definition of objects that shall be traded and how the logistic information shall be exchanged in association to this. Discrepancy is not allowed unless the actors, agents and the trading place in consultation change or primarily expand the standard.

The EBUS format is based in a certain degree on existing standards, but is not aiming at being generally in the same degree as EDIFACT, ASN.1 and other standards. The EBUS format shall be open for inspection from all and will mirror among other things the categorization and information, which is the basis for the invention. The format will initially not cover many types of objects, but will be expanded when the concept is being used in greater extent.

The solution is called EBUS on the basis of the abbreviations E-Business and E-Bus. The last-mentioned reflects that EBUS is an open bus in data technical sense as actors and agents openly can connect to their systems.

The EBUS format in the invention is more suitable for the purpose than other standards, allowing different definitions of documents, objects and procedures, because it with its unambiguous description of the trade objects are more directly sales oriented towards the trading place in the invention and because it can give faster and more cost efficient access to a bigger market than what is the case by use of actors' own definitions of objects and trade process.

The system is though such that it is open towards existing standards as example given EDI.

An example showing this can be sale of screws from a traditional ADB system directly to EBUS and use of XML as an alternative. A traditionally administrative data system is used for performing purchase, storing, order and invoicing (OLFI) has additional information in an existing commentary filed which is being used for telling the trading place which product (CAT) that shall be input/changed and which properties (ENT) that exist for this product.

Assume that the following information exist for product in an administrative data system:

Commodity number: 19812317-XT

Number: 23

Description: USSTD Screw 25×120 mm 8-18 Steel

Commentary Field:

UserTrade_CAT: 200-62-633-2

UserTrade_ACT: Phone)X(+47 22665522

UserTrade_ENT: Steel)X(8-18

UserTrade_ENT: Length)X(120

UserTrade_QTY: 23

Etc . . .

The OLFI system can use a commentary field for storing UserTrade information, additional fields can be used or it can be used translators linking the data of the OLFI system to “UserTrade_XXX” format. In the example above it is used a commentary field. When the actor in question wants to update his/her product information, the commentary field is transmitted to the trading place via an electronic medium. The trading place uses the format “UserTrade_XXX . . . ” to update the information about the actual sales object, install it as a new object or delete it.

If a translator is being used, as example given an EDI interpreter existing information can be connected/translated to UserTrade identifiers (“UserTrade_XXX”) and delivered to the trading place without it being necessary to fill in any additional information from the actor. This presupposes that the OLFI system has adequate information for defining the object. For en adequate support of trade against the inventive trading place it is natural that OLFI systems are expanded with better support for categorization of objects and trading process.

XML is an open and generic protocol, but says nothing about what actually shall be performed. On this background XML is well suited for transmitting information to/from the place of trade.

An example of a XML transfer of principally the same information as in the example above can be:

<?xml version=“1.0”?>
<itemupdate>
<from>Nut & Bolts Inc.</from>
<fromactomo>8712361</fromactomo>
<valid>now</valid>
<expire>#15.JAN.01#</expire>
<UTverb>UserTrade_CAT: 200-62-633-2</UTverb>
<UTverb>UserTrade_ACT: Phone )X( +47 22665522</UTverb>
<UTverb>UserTrade_ENT: Steel )X( 8-18</UTverb>
<UTverb>UserTrade_ENT: Length )X( 120</UTverb>
<UTverb>UserTrade_QTY: 23</UTverb>
Etc . . .
</itemupdate>

EBUS supports principally different forms for reading in data, but it is expected that XML and text transferred via email, FTP, HTTP or other Internet protocols will be the most used transport technologies. EDI is with its extreme complexity and extent expected to be less relevant, but can be supported by the system in a certain degree.

The practical part for updating of data takes place in that the server systems exchange data via EBUS and update databases in the trading place with the incoming information or deliver responses to the actors and agents with background in queries or system generated data.

### EXAMPLE

The trading system constitutes an integrated trading process, which is called UserTrade. It is focused on support for agent, rule based selections/calculations, controlled settlement processes and the underlying technology. The processes and technology will in the following partly be explained with examples from trading with cars. The process can nevertheless in principle apply for all type of objects, which are being introduced into the system. The description of the example is split in the following sections and are detailed in the subsequent paragraphs:

Initial Actions:

Definition of categories and objects

Agents register as car importers with detailed information about their service

Buyer and seller register in the UserTrade system and become actors

Inputting of Sales Object:

A car dealer in Germany inputs a car via Internet with local information and sales price in Germany

EBUS based trade

Presentation of Sales Object and Bidding:

A buyer in Norway is presented this car with Norwegian prices, including taxes and other costs

Rules and calculations

Proposal to agent is presented with price

Statistics and extrapolation

Bidding in a multi market situation

Ending of a Trade:

Status is changed on the object and an agent is selected by buyer

Documents are being issued and the settlement is being controlled in the UserTrade system

Initial Actions—Categori s and Objects are Defin d

Cars/models are categorized with definitions and detailed descriptions in category tables (e.g. “CAT” and “CATENT”). Fixed values and standard values are being used so that each single car can be ambiguously sold in the system. Standard values differ from fixed values by the fact that they can be changed by example given an actor when inputting of an object.

Inputting of a trade object, in this example a car, is being performed in that e.g. a 98 model Audi A6 2,4 Avant Tiptronic is classified (readily with the aid of recursion) in a database with a sectioning as follows: Car<-Audi<-A6<-96-99 2,4 Avant<-Tiptronic.

With the different levels in this list the car is almost unambiguously defined. The key information which is required for trading the car between different markets, is being defined in the database as properties connected to the actual car.

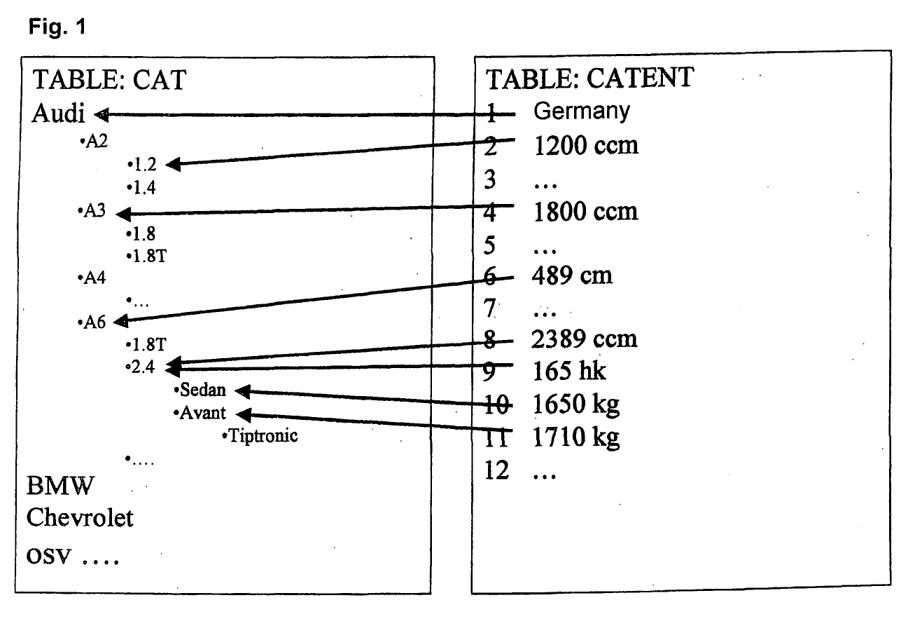

Typical table structures are sketched in FIG. 1. Two tables are used together for defining cars so precisely that one can use the information to different calculations. The table “CAT” is a recursive or categorized table defining how one can classify all actual car models. The classification can also be compared with a “normal” division into chapters with different levels of subchapters. The table “CATENT” contains values connected to the individual object in the categories if it points at the last level, or a group of objects if it points at the top or intermediate levels. In reality more information will usually exist for each car being defined. A lot of the information is connected to equipment variants, extra equipment and others, which primarily is information the buyer will want.

From the information which is given in the table example in FIG. 1, it can be deducted that the actual car as mentioned above is produced in Germany, it is 489 cm long, it has an 2389 ccm motor, is on 165 hk and the Avant model is 1710 kg heavy. This is information concerning all such cars and which is required among other things for the calculation of taxes when importing to Norway.

In addition to the definition of categories the tables also include information about countries, markets, rules and other information, which is shared by the modules in UserTrade.

The tables and the databases can advantageously be based on modern an flexible database solutions such as Oracle Database or Microsoft SQL Server, but it is also possible to base the data storage on other techniques and database forms.

Basic information as categories and other standard tables can be administrated with Internet web interface, directly against the database by e.g. SQL or via other tools as e.g. Oracle Form, Access database (via ODBC) or other techniques.

The trade system is typically based on that an Internet web interface on a PC or other client machine gets and delivers information via HTML/IP protocol to the central web servers. These generate pages by the aid of script tools, components and/or database connections as e.g. ODBC to central database servers. However, other protocols and client systems can be used.

Initial Actions—Agents Register as Car Importers with Detailed Information About Their Service

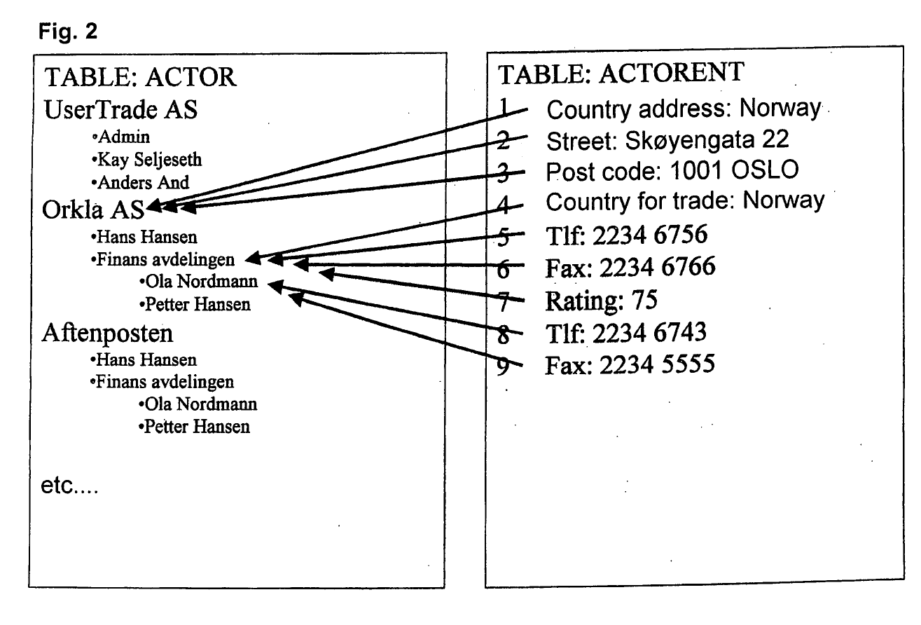

For defining agents the invention uses a table structure, which either is recursive or categorizing with own data fields for grouping of agents, as the example shows in FIG. 2.

Agents are defined in tables with information concerning contact information, addresses and normal information of the same sort as outlined in FIG. 2. In addition it is inputted a variable amount of information about type of agent, country which the agent can operate against, “rating” of the agent on the basis of earlier trades, “rating” of the agent based on economy, “limit” for amount which can be handled by the agent and other relevant information for description of the agent. This information is used for grouping the agents' properties with actual trade objects, markets being involved and the actors, which are to be served. In this example it can be deducted that Anders And in Østerndalen Bil Salg has a “Rating” of 35, the company can contribute when trading merchandise for up to 300.000 Euro and can trade cars from other countries to Norway. In addition Anders And is described as an offerer of agent services connected to Audi cars.

The registration of agents can take place by own registration via Internet or other media against the central systems/database or by the aid of dedicated resources for the registration work. These can work via Internet, via the central data systems or in any other suited way.

Initial Actions—Buy r and s II r Register in the Trade System and Become Actors

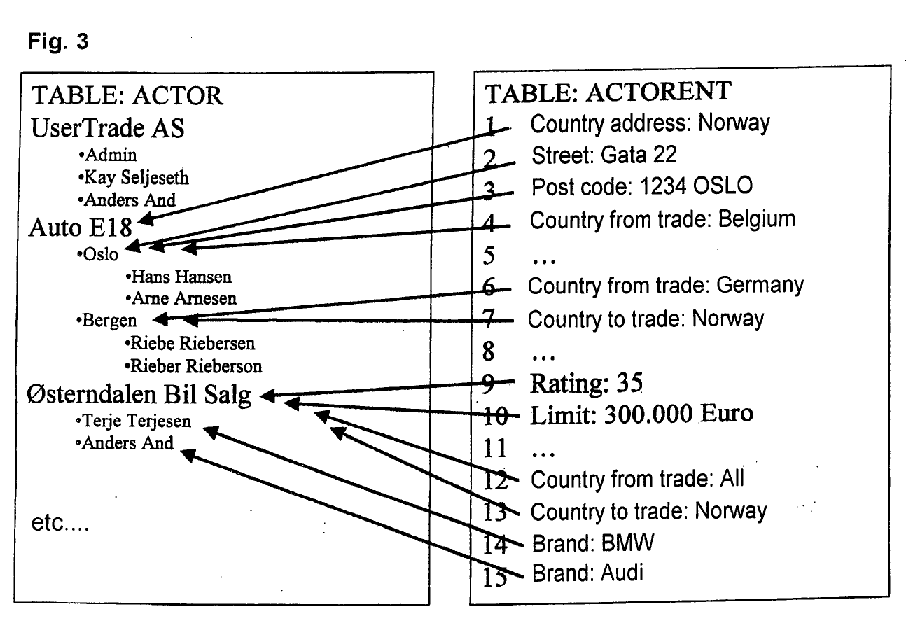

The table structure for actors is the same as in the case for agents, but the information which is being stored is usually somewhat more limited. See for example FIG. 3, where actors are defined in principle the same way as is the case in the last paragraph. In this figure detailed information is connected to actors on different levels. E.g. it is shown that “Ola Nordmann” has phone number “2234 6743” and said person works in “Finans avdelingen” in “Orkla AS”. “Orkla AS” has company address in “Norge”. For some actors it will though be a need for storing extensive information about properties and preferences. Key information like home country, rating, preferences of trade and the like is connected to an actor for use in selection of (AGENT), the rule systems (RULES) and the settlement system (TRADE PAY).

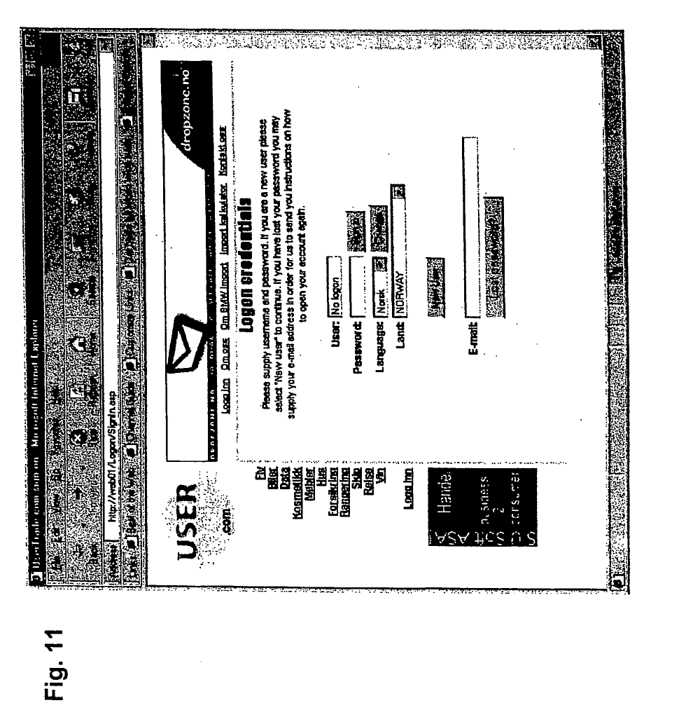

A screen image for logging on with the possibility for choice of language and wanted market is sketched in FIG. 11. This logon image can be used by both actors and agents in the system.

Inputting Sales Object—A Car Dealer in Germany Inputs a Car via Internet With Local Information and Sales Price in Germany

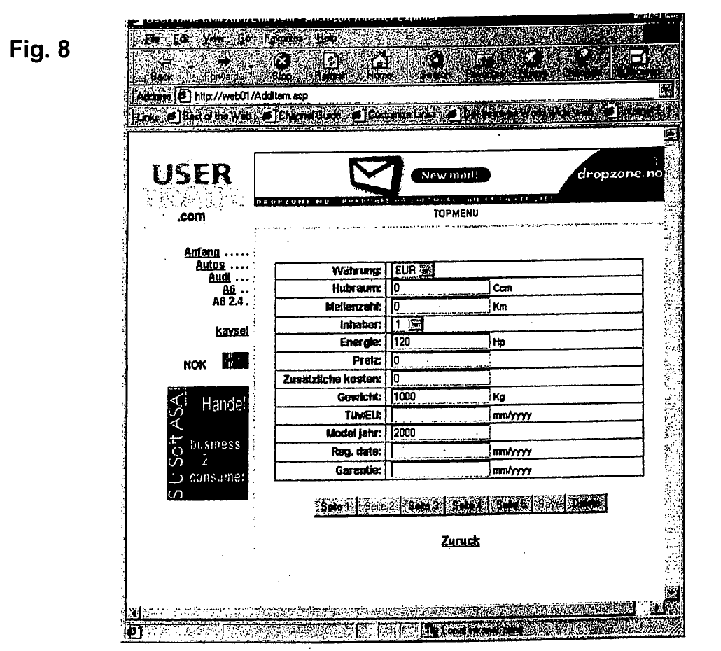

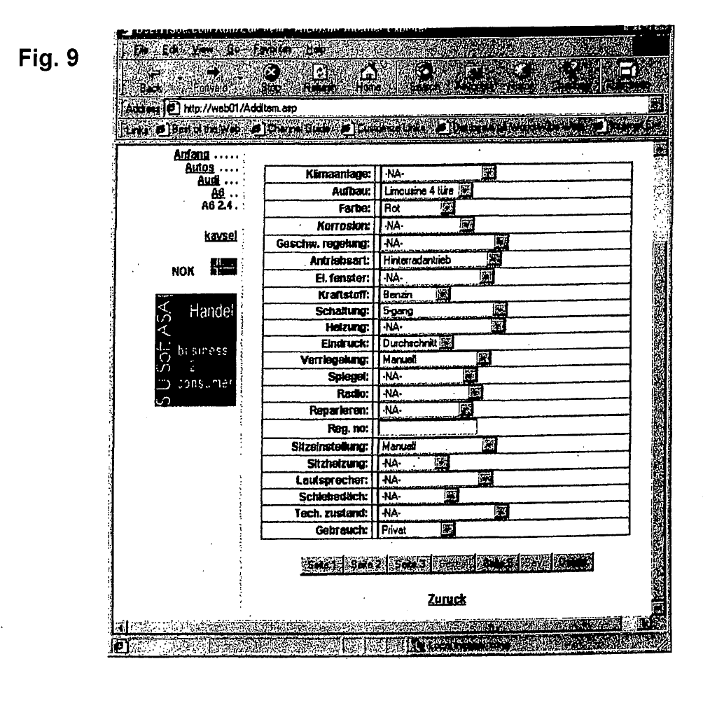

As shown in FIGS. 8 and 9 a seller is presented for a structured and detailed data logon picture, which can be filled out in such a way that the data given are unambiguously defined and is mainly not based on free text descriptions. FIG. 8 shows how a logon image for a car will look like for a seller with German as mother tongue. This function for inputting of a sales object consists of several pictures which the seller can change between for defining the car in the best possible manner. See also FIG. 9.

The information can normally be fed via en Internet terminal (browser) or another client system, but can also be fed directly into the system like the case might be with the use of EBUS solutions which get/deliver information directly to/from actors and agents in the system.

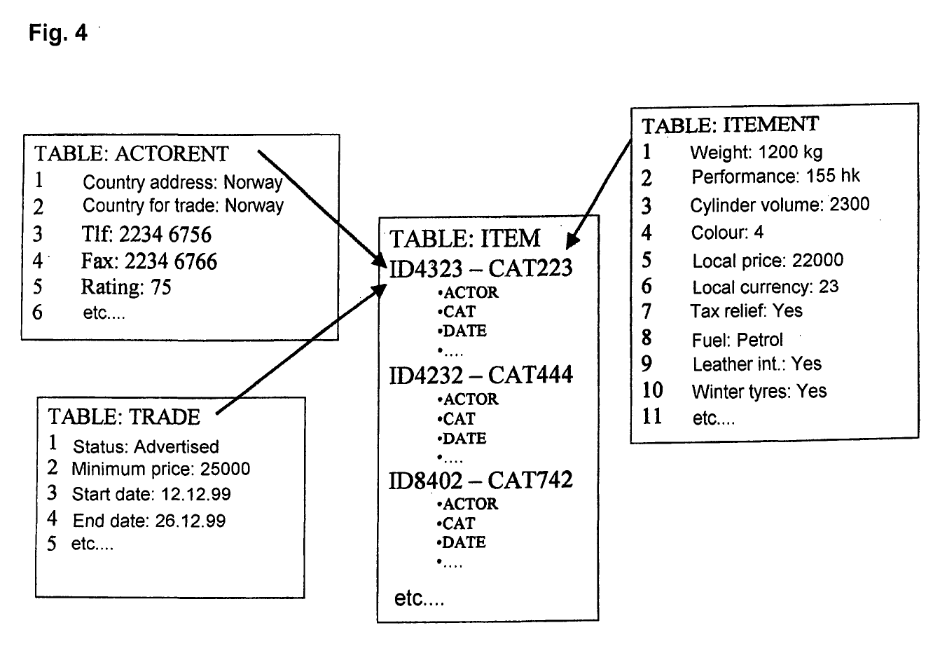

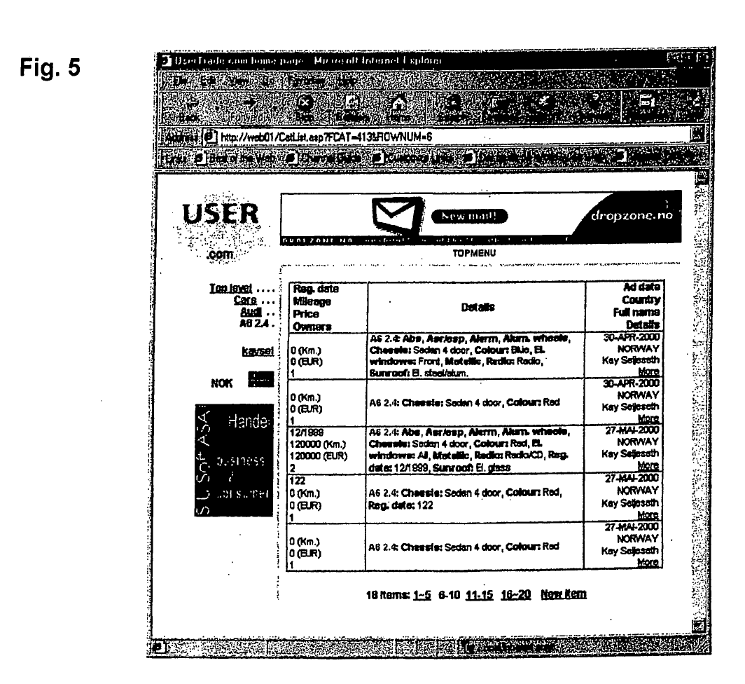

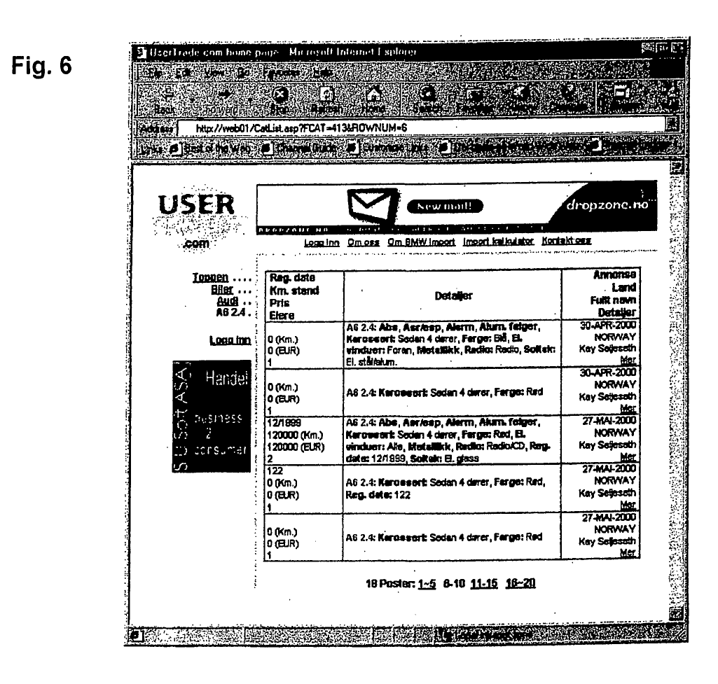

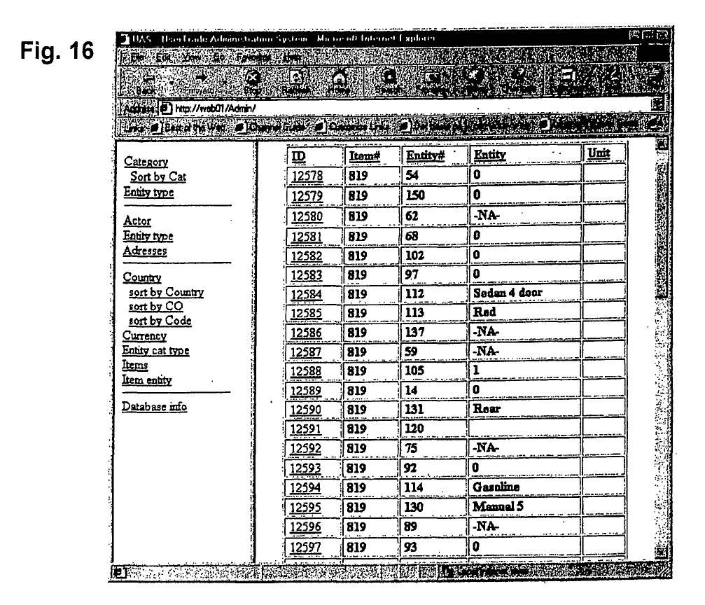

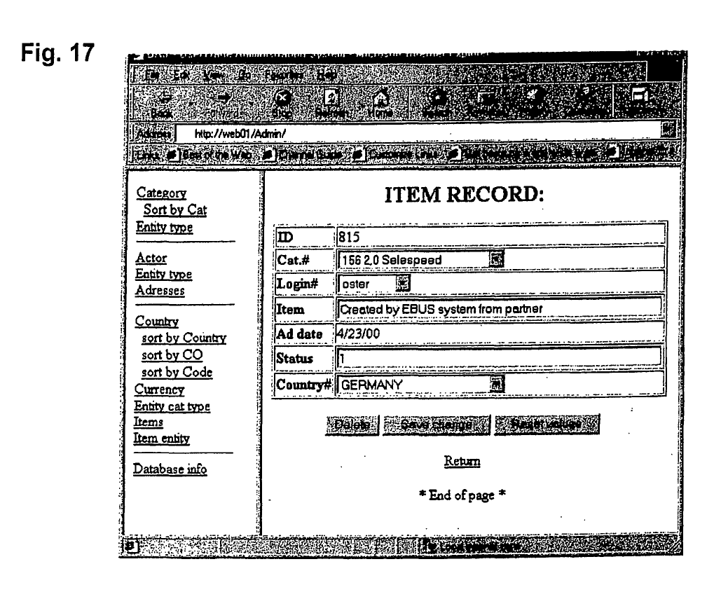

The received information will typically be read by an Internet web server and checked for errors in in-data before databases are updated. A new sales object like a car will be created in a sales object (“ITEM”) database with detailed properties in a property table (“ITEMENT”) as shown in FIGS. 4, 16 and 17. FIG. 4 shows a possible structure for the information, where FIG. 16 shows those data records denominated as “Table: ITEMENT” in FIG. 4, while FIG. 17 shows a data record denominated as “Table: ITEM” in FIG. 4. FIGS. 16 and 17 are screen images in the administrative system, while a user will see this information as shown e.g. in FIGS. 5 and 6. Standard values will be suggested for the seller when inputting the new object and in this example with car weight, yield, cylinder volume and the like information will be suggested as standard values as indicated in FIG. 8. Seller can change these values within given tolerances.

The system will also be able to suggest other properties or values by use of statistics or techniques for extrapolation. Example given, the system will be able to suggest sales price by statistically calculate a sales price based on prices achieved by selling other cars that are comparable.

Presentation of Sales Object and Bidding—A buyer in Norway is Introduc d for this Car with Norwegian Prices, Including Taxes and Other Costs

FIGS. 5, 6 and 7 show how cars as sales object are introduced in local language and with local prices to buyers. Foreign currency is given in Euro and some prices are given as 0 (zero) because the rules that are input do not include all the actual market constellations.

In the screen image in FIG. 5 it is chosen English language and the price is given in Euro for the buyer in receiver market. Sellers market is given as Norway and the price is calculated on the basis in this “from market” and the buyers “to market” based on current price calculation rules. Price mirrors sales price in from market, custom/taxes, agent costs and other costs connected to the trade described moreover.

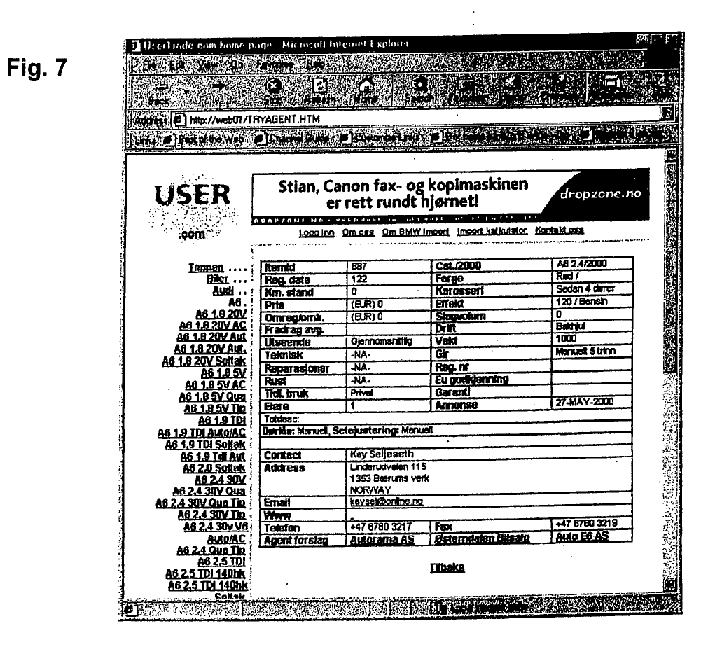

FIG. 6 shows the same data objects as in FIG. 5 presented in Norwegian language. Menus and descriptions contain the same information and the data objects are identical, but the system translates the content based on the language chosen by the user. The calculation is in this case the same because from and to market are as in FIG. 5, but another “price” will apply for other “to markets” and choice of agents. In FIG. 7 it is shown a detailed picture for a sales object. Further information about seller and agent(s) will exist in further screen images.

FIG. 4 shows how a part of the basic information in different tables are linked to the object for calculations of prices and presentation of various other information. The links are in this case based on database relations were data from a table points to another object, which in this case is the sales object. For use of rules/calculations this assembled information is used as basis and e.g. a whole set with rule information about car import to Norway will be linked to the object only based on that an actor is defined to be belonging in a market because a data record in a table states this.

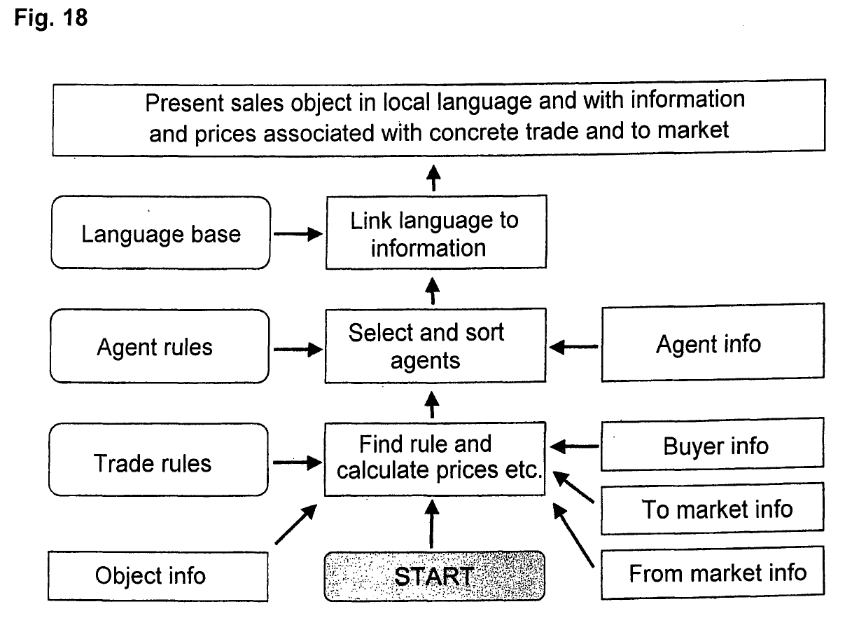

FIG. 18 describes schematically the process being used in the trade system for presenting localized information for relevant buyers. The process is technically typically performed in that program code on database and central server systems go through a series of selection queries against tables with information and by performing rules for making choices and selecting information for presentation for the user.

The process starts when known information (“Objectinfo”, “Buyer info”, “To market info”, “From market info”) is linked together in a query (“Find rule and calculate prices etc.”) for picking the right rule (“Trade rules”) and calculating price and find other special circumstances in the trade that the user needs to know. This query is succeeded by a new query (“Select and sort agents”) where also information about agents (“Agent info”) and those rules that applies for selection of agent (“Agent rules”) is assembled. The result from this last query is transferred in turn to routines for translation into languages (“Link language to information”), where information from “Language base” is used for translating or linking user language to the information.

The completed processed information is transferred to buyer or other actors/agents via example given Internet to a web browser for presentation. Data selection, the calculations and the presentation can be performed on the client's side in various degree, but will normally mainly take place centrally. Queries, rule processing, program code in general and calculations can take place in the database, in the central servers, in web servers or in components on server or client side.

Selection queries in the system typically happen with the help of SQL queries against a relational database, but can also happen in other ways. These queries fetch information, which the rule systems in AGENT and RULES use as parameters for performing calculations for further presentation of data. In the same way information from the queries is used for selecting desired language for presentation of the information.

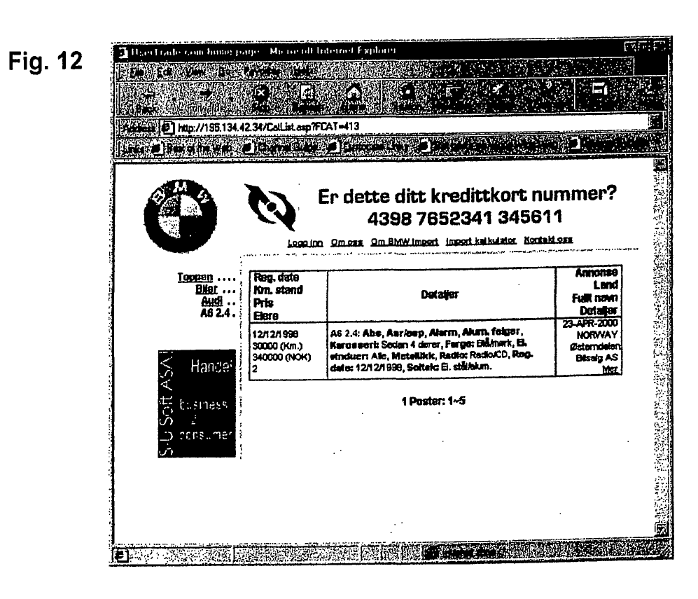

The result of this process is shown as examples in FIGS. 5, 6, 7 and 12. FIG. 12 shows an example on how the same database and system which are used for the general service, which is shown in FIGS. 4, 5, 6 and 7 in a limited selection is used for showing cars that the dealer himself has for sale. This distributor can enter his/her own cars, which will be visible for the buyer in the common database. On the dealer's own web service it is exclusively the dealer's own cars which are shown. The dealer can link his/her own administrative system up against the UserTrade trading place and/or use modules for order, storage, invoicing, economy control and other things, which are integrated in UserTrade's system.

The presentation form and what is included by data will vary with wanted design, degree of information and other. Whole or parts of the present information can be presented on an own system or transferred to other systems. This information is in all cases a result of the process and technology which constitute this invention.

Presentation of Sales Object and Bidding—Rules and Calculations

The trade system uses as mentioned above selection queries against the database(s) and fetches in this way information, which is used as basis for the rule system. Principally such a query can take place by example given the following simplified SQL command (it is used explanatory names in stead of real table names):

SELECT * (all fields) FROM Trading object, Seller, From Market, . . . (different tables) WHERE (Tradeobject.SellerID=Seller.ID) AND

(Tradeobject.HomecountryID=From market.ID) AND (Tradeobject.ID=“Chosen object”) AND (other criteria). . . ;

The details that are made available after this query will together with information and current buyer using the system, comprise the information which is required for finding the right rules and provide correct use of language.

Calculation of price can, based on the present information, take place by the use of example given calling of objects performing the calculations. This can example given, take place in the following way:

| | |
|---|---|
| RuleObject = Server.CreateObject | (Call RULES) |
| (“OUTRULES.CarRules”) | |
| RuleObject.FromMarket = From Market.ID | (State from market) |
| RuleObject.FromCurrency = | (State from the cur- |
| Tradeobject.Currency | rency of the trade object) |
| RuleObject.Amount = TradeObject.StartPrice | (State price in local |
| | currency) |
| RuleObject.ToMarket = | (State what is the |
| Session(“UserTradeCountry”) | buyer's market) |
| RuleObject.ToCurrency = | (State the buyer's de- |
| Session(“UserTradeCurrency”) | sired currency) |
| Etc. . . . | (Other parameters |
| | about objects etc.) |
| RuleObject.Calculate | (Perform the calcula- |
| | tions in RULES) |
| PriceToMarket = RuleObject.PriceOut | (Read the calculated |
| | price) |

The variable PriceToMarket can also be used as a part of the information that is introduced for the user. By the use of example given Microsoft Active Server Page and Internet technologies based on HTML such a presentation will typically be able to occur by the following HTML coding and program code:

<%@ Language=“VBScript” %>
<% Option Explicit %>
<% Response.Expires = 0 %>
<html>
<head>
<title>Show price in short form</title>
<%
′ queries to database (SELECT . . . )
′ calling rule object (RULES)
′ further processing of language, agents etc. when needed
%>
<h3>Price for Audi A6 2.4 Avant</h3>
<table width=“80%”>

<tr>

<td>Price Norway</td>
<td><%=PriceToMarket%></td>

</tr>
<tr>

<td>Currency</td>
<td><%=CurrencyToMarket%></td>

</tr>

</table>
</html>

The screen image, which is introduced for the user, can for instance look like as sketched in FIGS. 5, 6, 7 and 12. This example shows however not how language, including of agents and how other functions in the invention are attended to.

Presentation of Sales Object and Bidding—Proposal of Agent(s) is Presented With Price

The trade system typically uses in the same way as described earlier selection queries against the database(s) for picking basic data for further processing and choice of agents. As an example the invention can use the same query as shown above for finding the basic information:

SELECT * (all fileds) FROM Tradeobject, Seller, From-Market, . . . (different tables) WHERE (Tradeobject.SellerID=Seller.ID) AND (Tradeobject.HomecountryID=From-market.ID) AND (Tradeobject.ID=“Chosen object) AND (other criteria). . ;

Based on information from this query the invention will either use a rule system (as outlined above) for finding an agent or use one further selection query for finding the relevant agent(s).

Such a selection query will typically include sorting and certain criteria for limiting the selection of agents which are collected. An example of such a query is:

SELECT * (all fields) FROM Agent, Agent_Properties WHERE & _{—}
(Agent.ID = Agent_Properties.AgentID) & _{—}
(Agent_Properties.Limit >= ‘PriceToMarket’) AND _{—}
(Session(“USER_Country”) IN Agent_Properties.ToMarket) AND _{—}
(From-Market.ID) IN Agent_Properties.FromMarket) AND _{—}
Etc . . .
ORDER BY Agent_Properties.RatingFinance, Agent_Properties.RatingTrades
DESC;

This query given as an example will leave out agents that do not satisfy certain demands and sort the remaining based on economic situation and previous experiences (ratings). The criteria for a real selection and priority will typically be far more comprehensive and cover several long lists of criteria as an example geographic nearness, specialization on the current sales object and/or previous relations with the current actors. Further, it will typically be hidden in components and as “stored procedures” or functions in the database or the server environment.

The result can as an example be introduced as outlined in FIG. 7. A trade will usually require that only one agent is selected, but the trade system also covers selection/suggestions that comprise two or more agents for performing a trade.

Presentation of Sales Object and Bidding—Statistics and Extrapolation

In cases where it is desirable with statistical information or in various degrees is demanded a calculated value for an object the invention will be able to fetch statistics from objects with the same or similar properties and present this value. If the statistical basis is lacking, the object's properties are determined by extrapolation.

The following examples explain the technique which is a part of the invention:

A car is to be sold (a 98 model Audi A6-2.4 Avant) and seller does not know the weight of this car and has neither knowledge of the price which is reasonable as a starting point. By the fact that seller during inputting this car in the system inputs “?” in the price field and the weight filed and chooses a “propose value” function in other ways, the system will seek to find a probable price and weight. Based on that the system also has stored detailed information about similar cars this can take place. In this example it is assumed that information exist about such similar objects as follows:

| | | | |
|---|---|---|---|
| A6 1.8T Avant | 1998 | 295.000 | 1620 kg |
| A6 2.4 Avant | 1997 | 335.000 | No information |
| A6 2.4 Avant | 1997 | 330.000 | No information |
| A6 2.4 Sedan | 1997 | 310.000 | 1600 kg |

Based on this information the invention will be able to extrapolate that the weight with great probability is 1710 kg because the difference between 1.8T Sedan and 1.8T Avant is 110 kg. When 2.4 Sedan weights 1600 kg, the weight becomes: 1600 kg+110 kg=1710 kg.

The price can statistically be assumed to become approximately 345.000 based on a fairly right statistical calculation. More conditions than what is given here in the example will typically be used for making this type of calculations. For cars one will for instance at least also have to evaluate mileage and level of equipment to achieve a calculation which can be said to be real.

Presentation of Sales Object and Bidding—Bidding in a Multi Market Situation

As the trade system includes support for detailed object information and rules for calculation of the full price which buyers in different markets must count on paying, sale, auctions, “Co-Shopper” buys and mediating/trading happen with different prices in different markets, but with a common sales price/bidding price and currency in sellers market.

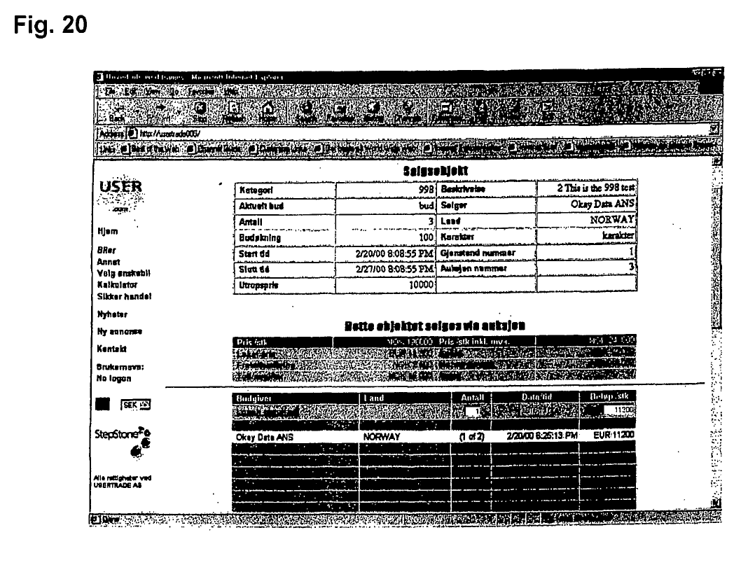

This situation is outlined in FIG. 20. As an example, a seller of a car in Germany can in an auction of the car see a bidder price on EUR 11.200 and a possible next bid on EUR 11.300. For a current buyer in Norway a bid on 11.300 (local currency) with taxes and other costs result in a real purchase price of NOK 241.000. At the same time a Swedish buyer will see a price of SEK 140.000 with all taxes for the purchase of the car to Sweden. Before a new bid is confirmed in local currency (here EUR price in Germany) a buyer will be introduced for this price that has to be paid in his/her home market.

This is the type of technique which causes that most types of trade with fixed and variable price can take place faster, more secure and with a more correct price concerning market across country boarders.

The risk of currency fluctuations is partly attended to in that buyer and seller operate with a likely price in the desired currency at all times, which is based on current international exchange rates. A trade which is completed, will take place with local prices connected to the exchange price which the trading place at all times uses. But risk of fluctuating exchange rates in a time after the trade is placed on the actors according to the current conditions. The settlement part of the trading place can however safeguard the actors and agents against currency fluctuations by performing the exchange against the bank immediately after the trade is completed or by balancing outstanding exchange positions with by/sale of currency.

A trade is Completed—Status Changes on the Object and Agent(s) is Chosen by Buyer

When a trade in a trading place is completed (buyer and seller agree via the trading place to trade), the object is moved from the open trading place to the “settlement place” by changing the status of the object to “trading completed”. In this process the buyer selects (possibly coordinated with seller) one or more agents for completing the trade if this is necessary.

Agent is informed via EBUS or e-mail, fax or in other ways that an assignment is registered and receives details about seller, buyer, object and other things that are necessary for completing the trade.

A trade is Completed—Documents are Being Issued and the Settlement Controlled in th Trading System

In the general part of the description it is explained use of documents and the process that takes place in a settlement control of the trade.

The data technical implementation is performed in that a data object for control of the settlement associated with the sales object is updated with those actions that take place and the status in which the trade object exist. This happens typically against a record in a table, but in the invention it is also associated with properties of the trading objects for control of the settlement.

Current statuses for settlement control of the trade object can as an example be:

1. Trade completed

2. Document X issued

3. Document Y issued

4. Payment of first rate approved

5. Delivery performed

6. Delivery approved

7. Payment performed

8. Payment approved

9. Rating received

Beyond this status control the invention will control the sales object in detail and also the price/payment by way of that the described properties are approved in the system by the actors or agents performing services in relation to the trade. FIG. 19 shows a schematic description of the process as follows:

From a trade is completed (“START”) a query is performed (“Documents”) where information about the trade and sales object (“Object/actor info”) is used for selecting the actual documents from “Document base”, which is sent to or presented for the actors and the agent(s). The process continues in that information is going in (“Payment info”) stating that a payment has occurred to the system. This implies that the condition (“Deposition”) is satisfied and the process continues in that agent or buyer perform “Control” of the merchandise and add the result of this information into the system compared against the present information (“Object/agent info”). After the control data are entered the process continues in that final price is calculated or in that the trade is interrupted in the module “Price stipulation”. Change of price can happen in that “Discrepancy rates” is used associated with “Object info” information. The process is ended in “Disbursements/delivery”.

As an example, a partly approval where some properties after control deviates from the description the seller has entered, might bring about that the price of the object is changed automatically and/or in that sanctions are introduced or other in relation to the actors and the trade.

A car which as an example is entered with the description “Perfect paint” by the seller, but that turns out to have “Minor paint injuries” after control, will with the invention allow the settlement system to automatically reduce the purchase price with a factor or a fixed amount based on the rules connected to the trade objects and which are a part of the settlement rules. This will assure that inputting of descriptions are made more precisely and increase the confidence to the system.

Language and Translation Techniques

Language translation takes place in the system by introducing quantitative information in a language form or by translating words or phrases. As an example, a car's technical condition will be defined with a number value with a certain meaning. On presentation this number value is presented with the associated local language phrase. Accordingly, the local language phrase is presented for he/she which inputs the object, but the value that is being stored is a number value defining the meaning. The following language lists are examples on how the system works:

| From seller (Norwegian) | Database | Buyer (English) |
|---|---|---|
| Perfekt stand −> | TechCond: 26535 −> | Perfect condition |
| Mindre lakkskader −> | Paint: 27675 −> | Minor paint |
| ABS Bremser (J/N) −> | ABS: −1 (boolean: true) −> | ABS Brakes |

Phrases and words are translated by defining phrases and words in other languages which are associated with the original phrase in the database. This can as an example take place as follows:

“Car” (ID Concept)

| | |
|---|---|
| Language ID: 4 (German) | “Autos” |
| Language ID: 1 (Norsk) | “Biler” |

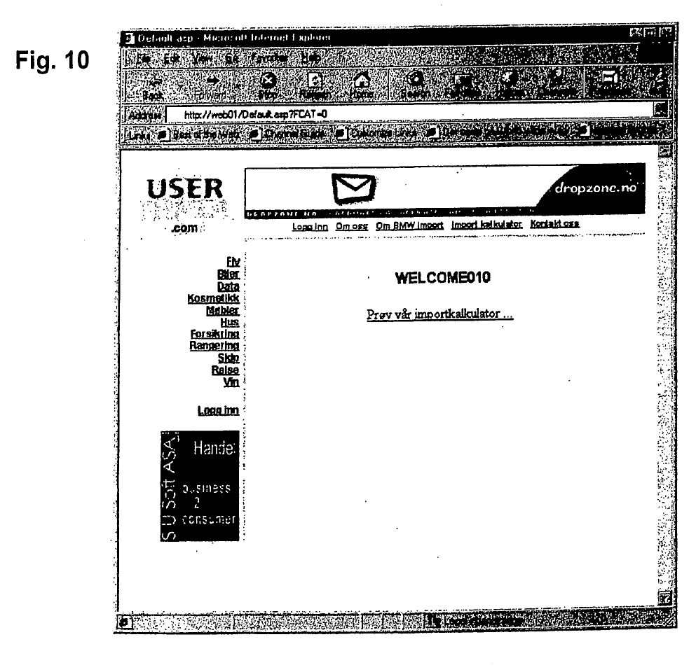

In FIG. 10 some examples of categories which might exist in a more developed version of the invention are shown. Under each choice in the menu on the left side new choices will appear which in the end unambiguously will define an object. For the example “Data” a number of menu choices might as an example be:

Data->PC'er->Tower Modeller->Intel 660 MHz->SCSI disker.

The text “WELCOME010” is moreover an example on language translation where the key phrase is not defined so far in Norwegian language. With that the system shows the key phrase instead of the text that must be defined.

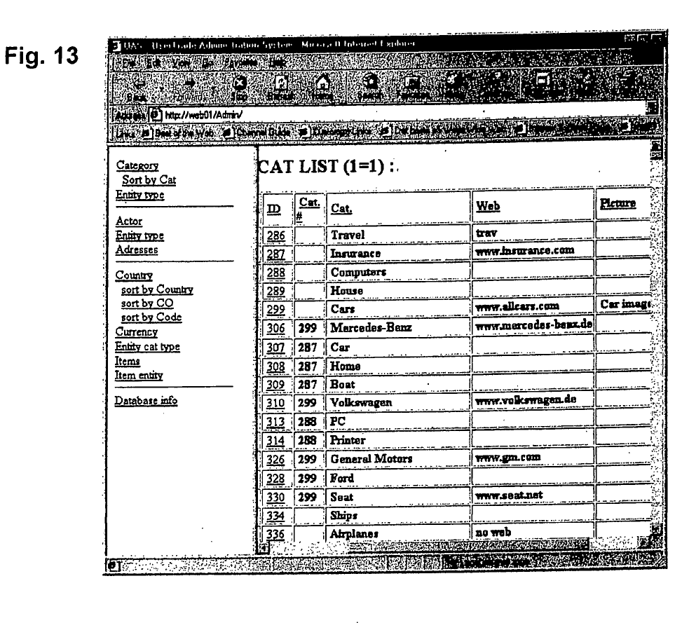

In FIG. 13 it appears how the administrative system shows the same categories that are shown in FIG. 10, but with the English phrase conceptions as in FIG. 10 shown in local language (Norwegian). The figure also shows how the recursion in this embodiment of the system takes place. “Cat.#” value for “Ford” is 299. This value points in turn to “ID” value for the category “Cars”. Further levels exist, but are not shown. Typically the value of “Escort” for “Cat.#” will be “328” because this is the “ID” value for “Ford”.

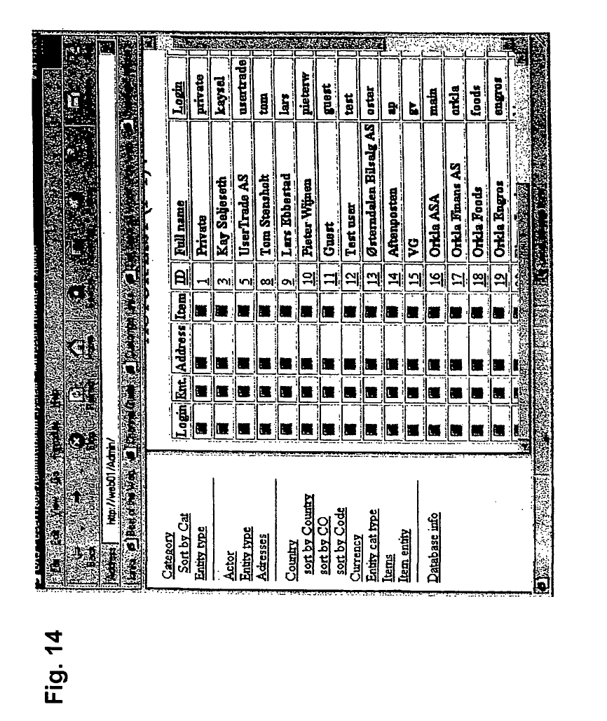

FIG. 14 shows how actors and agents are shown in the top level in the table for these in the database. Also this embodiment is based on recursion and definition of details by the use of pointers to the actors. As an example, values in the column “Address” states which address details (street, post code etc.) that applies for the single actor or group of actors. Specific properties as “Rating” and the like are defined in the data fields which are annotated “Ent.” (for entities) in the figure. The column “Item” gives the user a possibility to choose those sales objects as the current user has entered into the UserTrade system.

FIG. 5 shows some of the information which applies for countries that are defined completely or partly in the system. In the figures the columns have information about image of the flag, the two-country code for the country, international land code, primary currency type and a column (completely to the right) which tells what status the country has in the system.

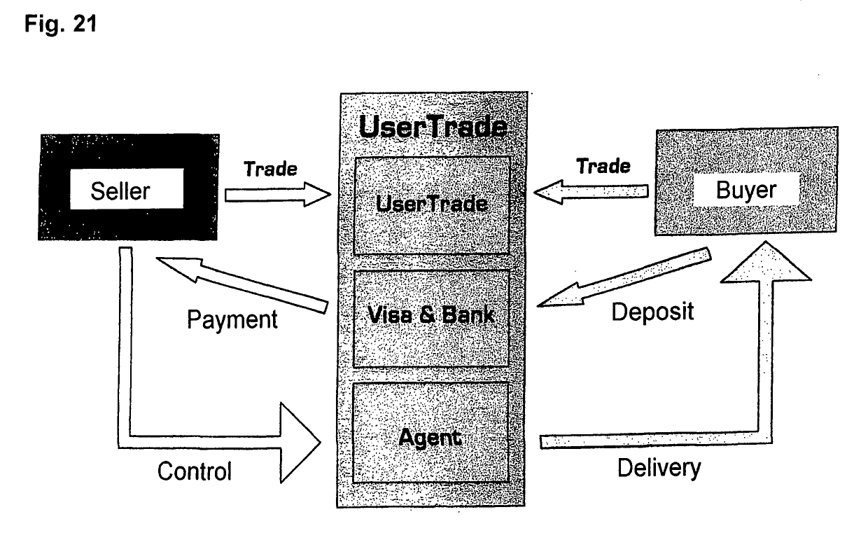

FIG. 21 is a superior description of the market place “UserTrade” as it will appear for the users. A typical trade process is as follows: “Seller” enters (“Trade”) one or more trade objects into the trading place “UserTrade” with detailed information. One or more “Buyer” (s) seeks information about the trade objects (“Trade”) on the trading place and finds an object which is bought. “Buyer” deposits (“Deposit”) whole or part of the amount to the trading place (“Visa & Bank”). “Seller” presents the trade object for control by “Agent” (possibly buyer) which constitutes a function in the trading place. “Agent” approves the object and releases with that the object for “Delivery” to “Buyer” and also “Payment” of the purchase sum to “Seller”.

Generally

Even though this invention describes a set of methods, processes, presentation forms, techniques for data definitions, functions and other it is clear that the invention also as an example comprises use of other media, other use areas, other data for presentation, other presentation forms, other transports, new clients and a number of other conditions. As an example one can within the scope of the invention leave out the settlement system, leave out language translation add new functions, introduce new techniques for translation, add in new payment forms and make a number of other obvious and not obvious changes.

Some possible use areas comprised by the invention beyond what seems to be obvious are:

Transport mediating and trade where forwarding agents, transporters, media and the like are selected based on that a constant, regular or single transport assignment is registered as a purchase object in the base. Objects can comprise goods, persons, energy, water, oil and everything demanding physical connections or radiolink/satellite based connecting links to transfer the object. Such a trade will be able to utilize the technology in AGENT, RULES and possibly TRADEPAY for completing the trade and settlement across markets better than today's solutions.

B2B (Business To Business) trading places where sellers and buyers perform in groups and where these crosses the traditional borders that are likely connected to such trading places. As an example one will with traditional B2B solutions typically not be able to connect a purchase of a certain type of screws of an American trading place for car producers with the purchases of a plane factory in Russia, because those often are very business sector oriented. The trading system which is described here will be able to collect these purchases across business sectors and markets in that prices, information about objects, import costs and other can be classified and gathered in such a way that the traditional market, language and business related borders are removed.

C2C (Consumer To Consumer) trading places or auction houses like QXL, EBay and others operate primarily in a limited market and due not define normal trading objects in such detail that information can be made available across borders and markets. Further, the definition of the objects in many cases are so hard to interpret and/or inaccurate that a satisfactory control of the delivery is not possible. With the trading system that has been described here objects can be defined in detail and sale conditions can be associated to the definition, such that interpretations and settlements become substantially simplified. Language translation is also an obvious added value.

B2C (Business To Consumer) trading places exist in a great number and are likely a big effort for those organizations that establish these. The starting point is generally that one shall sell products “internationally”, but because several languages, international prices and other are very resource demanding to enter and update for other markets than the primary market, a poorer result than expected is often achieved. The trading system addresses this in that actors/organizations can enter repeating sales objects (fixed objects) in the trading place or in that EBUS is used to integrate the actor's information into the trading place. When one of these solutions is used, the invention will attend to translation of languages, presentation of products, completing of trades and settlements if desired.

Even though embodiments of the invention have been described, the invention is not limited to these, as the scope of invention is defined by the appended patent claims.

1. System for trade and/or marketing in an electronic medium, comprising:
central systems for primary data storage and processing; and
an electronic place of trade connected with these central systems for advertising/marketing and trade of trade object,
characterized in that the electronic place of trade comprises:
means for automatically price settlement of the trade objects and settlement of conditions;
means for automatic selection of at least one agent for at least one actor in each single trade based on given criteria/parameters; and
means for specifying each single trade.

2. System according to claim 1, where the electronic place of trade further comprises means for trade object control and settlement, for safe settlement of the trade, which also comprises delivery of the trade object.

3. System according to claim 1, where the central systems comprise databases that include information and parameters associated with agents, sellers/buyers (actors), trade objects, markets and banks/payment systems.

4. System according to claim 1, where criteria for selection of agent(s) are linked to information about seller, buyer, trade object, markets in which these exist, and present information about the agent(s).

5. System according to claim 1, where the automatic agent selection means prioritize agents in that actual parameters/criteria are collocated and weighted mathematically to give objectively seen the best agent.

6. System according to claim 1, where the agent selection means comprise threshold values/limits for excluding agents that do not satisfy given demands.

7. System according to claim 1, where the agent selection means generate a list of agents in preferred sequence, between which the actor(s) subsequently can select.

8. System according to claim 1, where the price information and the agent information is introduced for the actor(s) dynamically on this client directly.

9. System according to claim 8, where the client is an Internet/HTML based interface, a traditional user interface, at telephony unit, WAP and/or other technologies.

10. System according to claim 1, where the trading system is designed as an open buss system such that actors simply can connect to the system.

11. System according to claim 1, where the automatic price settlement means and automatic agent selection means comprise rules stored as code in web sites, another client system, business objects, in another software, as functions in a database or in other ways in the central systems.

12. System according to claim 1, where the properties of a trade object are defined as standard values in the system or are defined by actor or agent.

13. System according to claim 1, where the properties of the trade objects are defined in such detail that they can be handled by all the means in the trading system in a quantified and controlled manner.

14. System according to claim 1, where the means for automatic price settlement and means for automatic agent selection comprise rules stored as modules with algorithms performed with actual parameters.

15. System according to claim 14, where the modules are selected based on the trade object's from-market and to-market and other parameters, such that a single object can be introduced with different prices, conditions and information in different markets by use of several rules.

16. System according to claim 14, where the rules are based on international customs tariffs and/or similar sources.

17. System according to claim 15, here the markets exist in different countries and the trade objects have defined properties which can be associated with several languages, in which the system comprises means for automatically presenting all information in several chosen languages for actors in the system.

18. System according to claim 1, where the electronic medium is Internet, WAP, teletext, telephony based information systems or the like.

19. System according to claim 1, where all costs as vat, customs, taxes, duties associated with the trade are included in the price settlement for the trade object.

20. Method for trade and/or marketing of trade objects in an electronic place of trade in an electronic medium where the electronic trading place is connected to central systems for primary data storage and processing, the method comprising:
advertising trade objects that are to be sold on the electronic trading place, characterized in
to conclude trade of the sales objects between actors or between the trading place and an actor,
where the trading place
automatically settles the price on the trade objects, and
automatically selects at least one agent for carrying out the single trade based on given criteria/parameters; and
to complete each single trade by the use of means for trade object control and settlement.

21. Method according to claim 20, where the means for trade object control and settlement are integrated in the trading place.

22. Method according to claim 20, where settlement of each single trade also comprises delivery of the trade object.

23. Method according to claim 20, comprising presenting the result from the price settlement and/or agent selection in the client system or storing it for later use.

24. Method according to claim 20, comprising generating a list of agents in prioritized sequence, in which subsequently the actor(s) can choose between.

25. Method according to claim 20, comprising prioritizing agents in that actual parameters/criteria are collocated and weighted mathematically to give objectively seen the best agent, the threshold values/limits excluding agents that do no satisfy given criteria.

26. Method according to claim 20, comprising
placing a trade object in a defined settlement process, containing a number of processing phases, and when a trade is completed, to control the process by changing status for the trade object and/or change of status for seller/buyer and/or agent(s) in a central database, where entry into a processing phase initiates a number of actions, while exit from a processing phase require fulfillment of one or more conditions.

27. Method according to claim 26, where actions comprise automatically or manually issuance of email, fax, transactions, publishing on Internet or other.

28. Method according to claim 20, comprising after settlement of a trade to issue general documents and transactions for merchandise, and to issue documents adapted to the object's category for capital goods.

29. Method according to claim 28, where documents comprise paper based documents, documents based on email content, web sites or other media.

30. Method according to claim 20, comprising controlling the trade object's condition before payment to seller either by the aid of agent or in that the buyer himself/herself approves the trade object, where the detailed information from the central systems are the basis for the approval.

31. Method according to claim 30, where the trading system automatically can change price and/or other conditions connected to the trade on the basis of control of the trade object against the detailed information in the central systems.

32. Method according to claim 20, where in a trade where buyer is the control function, to perform the following:
to conclude a trade,
to issue to buyer, seller and agent(s), documents which describe in detail the trade object and the trade in detail,
to send deposit slip to buyer,
to approve payment, and subsequently perform one of the two following steps:
if buyer approves the object, to pay out the amount to seller, and
if the buyer does not approve the object, to pay out the deposited amount back to buyer.

33. Method according to claim 20, comprising stipulating price for the sales objects for markets existing in different countries by letting all costs as vat, customs, taxes and duties connected with the trade be included in the price stipulation for the trade object.

34. Method according to claim 20, and where the trade objects have defined properties which can be linked to several languages, the method comprising automatically presenting information on several chosen languages for actors in the system.
